(19) United States
(12) Patent Application Publication
(10) Pub. No.: US 2011/0039573 A1
(43) Pub. Date: Feb. 17, 2011

(54) ACCESSING POSITIONAL INFORMATION FOR A MOBILE STATION USING A DATA CODE LABEL

(75) Inventor: Edward Thomas Lingham Hardie, Menlo Park, CA (US)

Correspondence Address: QUALCOMM INCORPORATED, 5775 MOREHOUSE DR., SAN DIEGO, CA, 92121, US

(73) Assignee: QUALCOMM Incorporated, Dan Diego, CA (US)

(21) Appl. No.: 12/540,498

(22) Filed: Aug. 13, 2009

(51) Int. Cl. H04W 24/00

(52) U.S. Cl. 455/456.1

(57) ABSTRACT

Positional information for a mobile station is acquired using a data code label and the positional information is updated as the mobile station moves without the need for signals from a Satellite Positioning System (SPS), such as the Global Positioning System (GPS). The data code label is read and information encoded within the data code label is used to obtain positional information, which may be, e.g., a digital map, directions, or non-navigational information, which may be provided via a display or speakers. The positional information may be referenced to a local coordinate system or a global coordinate system. The position of the mobile station is updated using inertial sensors within the mobile station and/or using a measured radio signal and a wireless access point almanac that may be obtained using the information encoded within the data code label. Updated positional information for the mobile station is then provided.

### BACKGROUND FIELD

The present method and apparatus relates generally to positioning systems for mobile stations, such as cellular or other wireless communication devices, and more specifically to acquiring and updating positional information for a mobile station using data code labels.

### RELEVANT BACKGROUND

Accurate position information of mobile station, such as cellular or other wireless communication devices, is becoming prevalent in the communications industry. A Satellite Positioning System (SPS), such as the Global Positioning System (GPS), offers an approach to providing wireless mobile station position determination. For example, a GPS user can derive precise navigation information including three-dimensional position, velocity and time of day through information gained from satellite vehicles (SVs) in orbit around the earth. The signals that are received from the SVs may be weak. Therefore, in order to determine the position of the receiver, the receiver must be sufficiently sensitive to receive these weak signals and interpret the information that is represented by them.

One limitation of current SPS receivers is that their operation is limited to situations in which multiple satellites are clearly in view, without obstructions, and where a good quality antenna is properly positioned to receive such signals. As such, they normally are unusable in areas with blockage conditions, such as where there is significant foliage or building blockage (e.g., urban canyons) and within buildings.

### SUMMARY

Embodiments disclosed herein provide for the acquisition of positional information for a mobile station using a data code label and updating the positional information as the mobile station moves without the need for signals from an SPS, such as GPS. The data code label is read and information encoded within the data code label is used to obtain positional information, which may be, e.g., a digital map, directions, or non-navigational information, which may be provided via a display or speakers. The positional information may be provided with reference to a local coordinate system or a global coordinate system. The position of the mobile station may be updated using inertial sensors within the mobile station and/or using a measured radio signal and a wireless access point or femtocell almanac that may be obtained using the information encoded within the data code label. Updated positional information for the mobile station is then provided.

### BRIEF DESCRIPTION OF THE DRAWINGS

FIG. 1 illustrates a block diagram showing a system in which a mobile station acquires positional information using information from a data code label.

FIG. 2 is an example of a data code label in the Quick Response code format.

FIG. 3 is an illustrative block diagram of a mobile station capable of acquiring and updating positional information using encoded data from a data code label.

FIG. 4 is a flow chart illustrating a method of acquiring and updating positional information using a data code label.

FIG. 5 illustrates an example of a simple digital map and various positions of a mobile station that may be displayed on the visual display of the mobile station.

### DETAILED DESCRIPTION

A system and method described herein uses a data code label to acquire positional information, which may be updated without the need for signals from an SPS. The system may include a mobile station that uses a data code label to acquire position information and uses internal sensors to update the positional information, such as the current position of the mobile station. The positional information may include a digital map with the position of the mobile station, navigation instructions or non-navigational information about the position of the mobile station. It should be understood that the positional information may be referenced to a local coordinate system or a generalized global coordinate system, such as the WGS84 coordinate system used with GPS.

As used herein, a mobile station refers to a device such as a cellular or other wireless communication device, personal communication system (PCS) device, personal navigation device, Personal Information Manager (PIM), Personal Digital Assistant (PDA), laptop or other suitable mobile device which is capable of receiving wireless communications. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above is also considered a “mobile station.”

Acquiring positional information for a mobile station using a data code label as described herein may be advantageous if the mobile station does not have SPS capabilities or if the SPS system is inactive or in locations where SPS may not work adequately, e.g., in locations that suffer from blockage conditions. Blockage conditions may exist where the SPS receiver in the mobile station has difficulty acquiring and/or tracking SPS signals from SPS satellites. For example, blockage conditions may exist in indoor environments, in urban canyon environments, and certain outdoor environments with natural obstacles, such as foliage and interfering topology.

Navigation without SPS or in blockage conditions presents two related problems: keeping an accurate sense of position and having access to local information about the topology. Navigation without the benefits of SPS is hampered by the relative difficulty of substituting other technologies. For example, almanacs of wireless access points can supply some data, but they may be expensive to compile and the source of almanac data appropriate for a local area may not be obvious to the user of a mobile station. Another example is inertial sensors, which may provide information based on the tracking of movement through dead reckoning, but these tend to amass errors over time. These techniques can benefit from access to information which associates location information with a specific position as well as from access to information which associates a position with related almanac data or available maps.

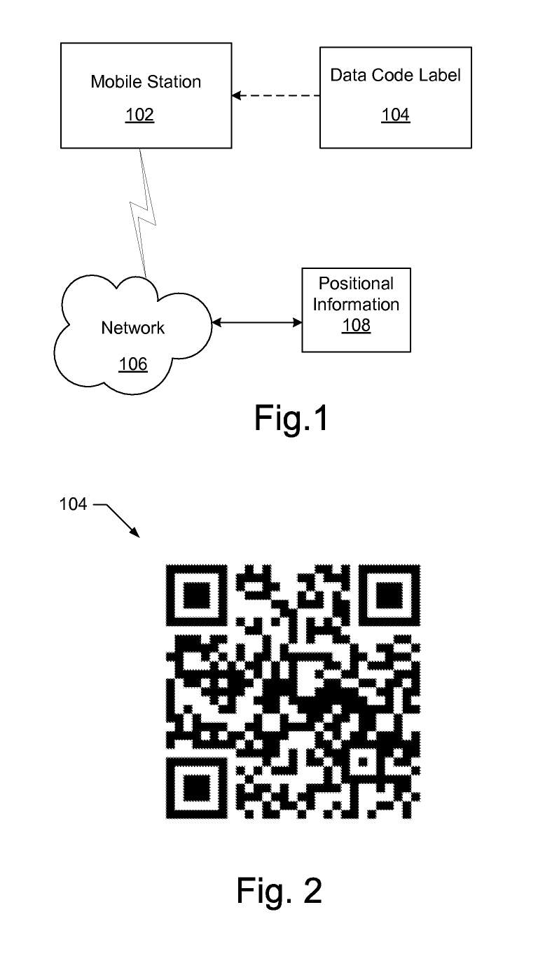

FIG. 1 illustrates a block diagram showing a system in which a mobile station 102 acquires positional information from a data code label 104 that may be used for navigation. The acquired positional information may include the position of the data code label 104 and therefore the mobile station 102, with respect to a coordinate system, which may be a local coordinate system or a generalized global coordinate system, such as the WGS84 coordinate system. The acquired positional information may also include, e.g., navigation instructions or a map of the local environment. In some embodiments, the acquired positional information may also include almanac data, which may be used to assist in navigation.

The data code label 104 is a physical tag that is attached to a location that is accessible to the mobile station 102, such as at an entrance or directory sign to a building, or other accessible location. The data code label 104 may be, e.g., a Quick Response (QR) code, which is a matrix code created by Japanese corporation Denso-Wave. Other types of bar codes or machine readable representations of data, including one dimensional bar codes or optical data matrix style codes, such as Data Matrix code, Semacode, Maxicode, Aztec Code may be used if desired. If desired, non-optical data code labels may be used, such as RFID tags. The data code label 104 may be encoded with a hyperlink with, e.g., a Uniform Resource Identifier (URI), which can be used by the mobile station 102 to access positional information 108, which may be stored on a server, and is accessed through network 106, such as the Internet. FIG. 2, by way of example, is a data code label 104 in the QR code format that is encoded with the URI “http://www.example.com”. If the data code label 104 is capable of encoding information in a sufficiently dense manner, e.g., using colorized QR codes, the data code label 104 may be used to pass the positional information directly to the mobile station 102 without the use of a hyperlink.

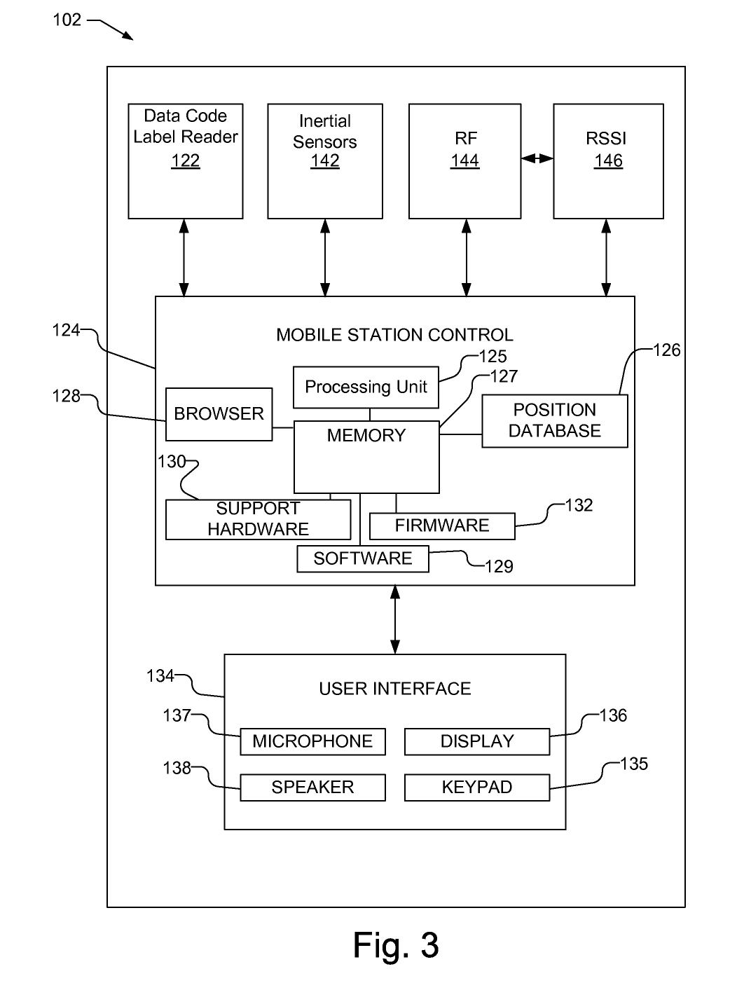

FIG. 3 is a block diagram of a mobile station 102 capable of navigation using information obtained from a data code label 104 (FIG. 1). As illustrated, mobile station 102 includes a data code label reader 122 that communicates with a mobile station control 124. The mobile station control 124 is provided by a processing unit 125 and associated memory 127, support hardware 130, software 129, and firmware 132. It will be understood as used herein that the processing unit can, but need not necessarily include, one or more microprocessors, embedded processors, controllers, application specific integrated circuits (ASICs), digital signal processors (DSPs), and the like. The term processing unit is intended to describe the functions implemented by the system rather than specific hardware. Moreover, as used herein the term “memory” refers to any type of computer storage medium, including long term, short term, or other memory associated with the mobile station, and is not to be limited to any particular type of memory or number of memories, or type of media upon which memory is stored.

It should be understood that the data code label reader 122 may operate in conjunction with the mobile station control 124 to read and decode the data code label 104, e.g., using suitable data code label reading software in the mobile station control 124. For example, the data code label reader 122 may be a camera that images the data code label 104, which is decoded by the mobile station control 124. The data code label reader 122 may be a bar code reader or an RFID reader. The data code label reader 122 may be configured to read Quick Response codes. If desired, the data code label reader 122 may be a dedicated reader that extracts the encoded data from the data code label 104 and provide the extracted data to the mobile station control 124.

With the encoded data extracted from the data code label 104, the mobile station control 124 accesses the network 106 (FIG. 1) and is directed to a server containing the linked positional information 108, e.g., navigation information, a digital local map and/or almanac information. The mobile station 102 may access the network 106 through a wireless network radio receiver/transmitter (RF 144) that is capable of connecting to a network through, for example, a wireless access point or femtocell. The RF 144 may connect to a wireless network such as Wireless Wide Area Networks (WWAN), Wireless Local Area Network (WLAN) or any other suitable network.

By way of example, if the data encoded in the data code label 104 includes the keyword http://, the mobile station control 124 may launch a browser 128 on the mobile station 102 and direct the browser to the encoded URI. The mobile station controller 124 may download the positional information 108 with an initial position of the mobile station 102. The positional information 108 may include, e.g., navigation instructions, a digital map of the local environment, as well as almanac of local, for example, wireless access points or femtocells that may be used to assist in navigation. The positional information 108, such as navigation instructions or a digital map including the initial position of the mobile station 102, may be shown in a visual display 136 in the user interface 134 of the mobile station 102. The user interface 134 may include features such as a keypad 135, microphone 137 and speaker 138. Where the positional information 108 includes navigational instructions, the instructions may be provided via the speaker 138 as opposed to or in addition to the display 136.

The positional information 108 including the position of the mobile station 102 is stored and updated in a position database 126 in the mobile station control 124. As the mobile station control 124 determines that the position of the mobile station 102 changes, the position database 126 is updated with the new position. The updated positional information can then be provided, e.g., by displaying the digital map with the new position on the display 136 or by providing additional navigation instructions on the display and/or via speaker 138. Inertial sensors 142 within the mobile station 102 may be used to determine that the position of the mobile station 102 has changed. Inertial data, including the direction and magnitude of movement of the mobile station 102, is provided by the inertial sensors 142 to the mobile station control 124, which then updates the position in the position database 126. Examples of inertial sensors that may be used with the mobile station 102 include accelerometers, quartz sensors, gyros, or micro-electromechanical system (MEMS) sensors used as linear accelerometers.

Once the positional information is downloaded, the mobile station 102 can navigate using the inertial sensors 142 even after the radio has been turned off, e.g., in “airplane mode” on a cell phone. Moreover, if the data code label 104 is capable of embedding the positional information, the mobile station 102 can obtain the map and navigate while in “airplane mode”.

With the use of the radio, a change in position of the mobile station 102 may also or alternatively be detected with reference to, for example, a wireless access point or femtocell almanac, which may be downloaded, e.g., at the URI embedded in the data code label 104. For example, a wireless access point almanac is, e.g., a database of the signal strengths of wireless access points for different positions with respect to the local map 108. As illustrated in FIG. 3, the mobile station 102 may include a received signal strength indicator system (RSSI) 146 that is connected to the RF 144 and the mobile station control 124. The RSSI system 146 may determine and monitor the signal strength of any radio signal (e.g., wireless access point or femtocell signals) received by the RF 144 and provide the measured signal strength to the mobile station control 124. The measured radio signal strength may be compared to the downloaded wireless access point or femtocell almanac database. The current position of the mobile station may be determined to lie in an area that corresponds to the data point in the wireless access point or femtocell almanac with the highest correlation to the measured radio signal strength.

The methodologies described herein may be implemented by various means depending upon the application. For example, these methodologies may be implemented in hardware, firmware, software, or a combination thereof For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof

For a firmware and/or software implementation, the methodologies may be implemented with modules (e.g., procedures, functions, and so on) that perform the functions described herein. Any machine-readable medium tangibly embodying instructions may be used in implementing the methodologies described herein. Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

For example, software 129/firmware 132 code/instructions may be stored in a computer-readable medium such as memory 127 and executed by processing unit 125 and may be used to run the processing unit and to perform/control the operations of the mobile station 102 as described herein. For example, a program code/instructions stored in a computer-readable medium, such as memory 127, may include program code to decode a data label that is read by the data code label reader 122, to obtain positional information and a position using the decoded data code label, to provide the positional information with the position of the mobile station, and update the positional information of the mobile station when there is a change in position and to provide the updated positional information. The computer-readable medium may include program code to update the position of the mobile station using inertial data provided by inertial sensors 142. Additionally, the computer-readable medium may include program code to obtain a local wireless access point or femtocell almanac using the decoded data code label, to measure and monitor the strength of a signal from one or more wireless access points or femtocells that are in the local wireless access point or femtocell almanac, and to update the position of the mobile station using the local wireless access point or femtocell almanac and the measured strength of the signal.

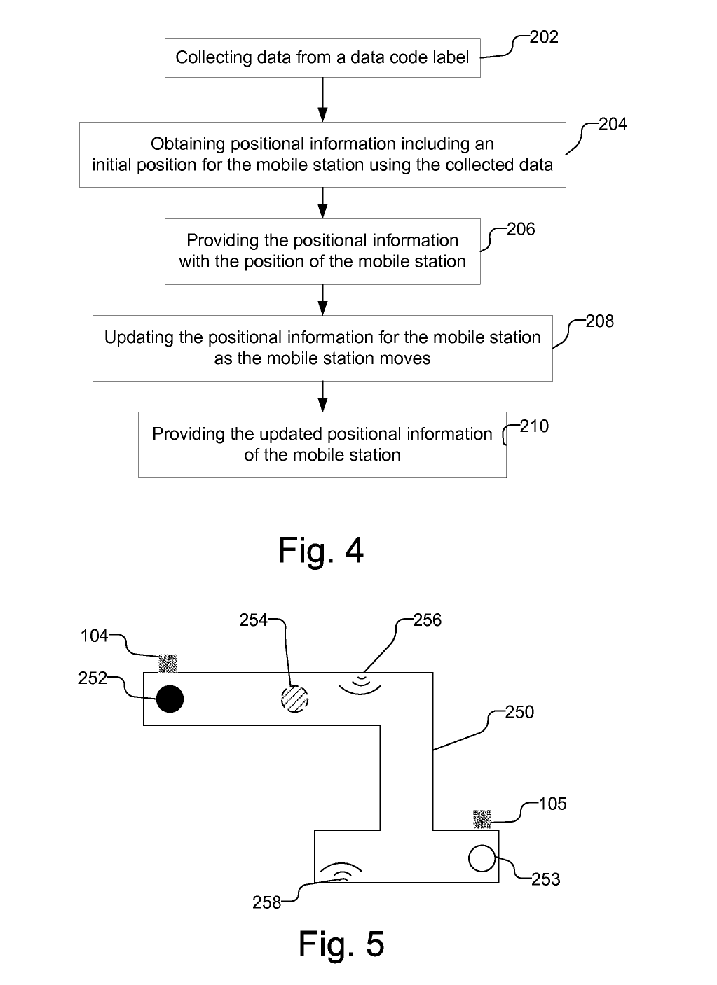

FIG. 4 is a flow chart showing a method of navigation using a data code label. As shown, data from a data code label is collected (202) by the mobile station 102. By way of example, a camera in the mobile station 102 may be used as the data code label reader 122 (FIG. 3) to capture an image of the data code label 104 (FIG. 1) that is located at the entrance or directory sign of a building, such as a hospital, museums, shopping centers, etc. The mobile station control 124 processes the image to decode the data code label 104. Using the decoded data, positional information, including the initial position of the mobile station 102 may be obtained (204). For example, a URI encoded in the digital code label 104 may be used to access and download the positional information with the initial position of the mobile station 102 via a wireless network. The positional information may include a digital map of the local environment or navigation directions for the local environment. The positional information may also include a wireless access point or femtocell almanac, for example. The positional information is provided by the mobile station (206), e.g., via display 136 or speaker 138 shown in FIG. 3.

The positional information for the mobile station 102, such as the position of the mobile station 102 referenced to the local coordinate system or global coordinate system, is updated (208). The position of the mobile station 102 may be updated based on signals from the inertial sensors 142 or based on a comparison of a measured strength of a radio signal to, for example, a downloaded wireless access point or femtocell almanac. For example, as the mobile station approaches wireless access point or femtocell 256, shown in FIG. 5, the radio signal strength will increase. By comparing the measured radio signal strength to the downloaded almanac, the position of the mobile station may be determined with respect to the local or global coordinate system. The updated positional information for the mobile station 102 is then provided (210), e.g., via display 136 or speaker 138.

FIG. 5 illustrates one embodiment of downloaded positional information in the form of a simple digital map 250 and initial position 252 of the mobile station 102 that may be displayed, e.g., on the visual display 136 of the mobile station 102. The digital map 250 may be referenced to a local coordinate system or to a global coordinate system, such as WGS84. The digital map 250 and initial position 252 may be accessed and downloaded using the data decoded from the data code label 104. Alternatively, if the data code label 104 is capable of encoding information in a dense manner, e.g., using colorized QR codes, the digital map 250 and initial position 252 may be encoded within the data code label, and thus, the mobile station can obtain this information directly from the data code label. As illustrated in FIG. 5, the digital map 250 may show additional information, such as the location of data code labels 104 and 105, and wireless access points or femtocells 256 and 258. The data code label 105 illustrated in FIG. 5 encodes different information, e.g., a different URI, which may include the same digital map, but a different position 253 for the mobile station. It should be understood, that FIG. 5 illustrates a relatively simple digital map 250 of a local indoor environment for illustrative purposes and that the digital map 250 may be as complex as desired or needed. For example, the digital map 250 may include multiple levels, rooms, etc. and may include textual and/or graphical information. Moreover, the digital map 250 is not limited to indoor environments. For example, the digital map 250 may be used for any outdoor environments, particularly where SPS navigation is not accessible due to blockage conditions or is simply not available on the mobile station.

As the mobile station 102 moves, the position of the mobile station 102 with reference to the local or global coordinate system is updated and the updated positional information is provided, as illustrated in FIG. 5 by the updated position 254. Because inertial sensors tend to amass errors over time, a wireless access point or femtocell almanac, for example, may be used in conjunction with the inertial sensors to minimize errors. Additionally, by collecting data from different data code labels, e.g., data code label 105 in FIG. 5, and downloading the digital map and the position associated with the different data code label, the position of the mobile station 102 may be periodically updated or corrected.

In another embodiment, the positional information may include navigation directions that may be referenced to a local coordinate system or to a global coordinate system, such as WGS84. For example, a directory sign may include a different data code label associated with each entry on the sign. Navigation directions to a desired destination may be accessed and downloaded using the data decoded from the data code label on the directory sign associated with the desired destination. The navigation directions maybe textual and displayed on the visual display 136 or auditory and provided by speaker 138. As the position of the mobile station 102 is updated, the mobile station 102 may provide updated positional information in the form of additional directions.

The positional information may also include other information about the position of the mobile station 102, including non-navigational information such as information about the current position or objects near the current position. By way of example, in an environment such as a museum, a data code label maybe used to access positional information in the form of information about items near the current position of the mobile station 102, which again may be provided via display 136 or speaker 138. As the position of the mobile station 102 is updated, the mobile station 102 may provide updated positional information, e.g., information about items at the new position of the mobile station.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). The techniques are not restricted to global systems (e.g., GNSS) for SPS. For example, the techniques may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk/disc includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
collecting data from a data code label;
obtaining positional information for a mobile station using the collected data;
providing the positional information for the mobile station;
updating the positional information as the mobile station moves; and
providing updated positional information for the mobile station.

2. The method of claim 1, wherein the positional information comprises a digital map and a position for the mobile station, wherein updating the positional information comprises updating the position of the mobile station, and providing updated positional information for the mobile station comprises displaying the digital map with the updated position of the mobile station.

3. The method of claim 1, wherein the positional information comprises directional information.

4. The method of claim 1, wherein the positional information comprises non-navigational information.

5. The method of claim 1, wherein updating the positional information of the mobile station comprises using inertial sensors in the mobile station to sense movement of the mobile station.

6. The method of claim 1, wherein the positional information comprises a local wireless access point almanac on the mobile station, the method further comprising receiving a signal from one or more wireless access points that are in the local wireless access point almanac, wherein updating the positional information of the mobile station comprises using the local wireless access point almanac and the signal from the one or more wireless access points to update the position of the mobile station.

7. The method of claim 6, further comprising monitoring the strength of the signal from the one or more wireless access points, wherein the strength of the signal from the one or more wireless access points is compared to the local wireless access point almanac to determine the position of the mobile station.

8 The method of claim 1, wherein the positional information comprises a local femtocell almanac on the mobile station, the method further comprising receiving a signal from one or more femtocells that are in the local femtocell almanac, wherein updating the positional information of the mobile station comprises using the local femtocell almanac and the signal from the one or more femtocells to update the position of the mobile station.

9 The method of claim 8, further comprising monitoring the strength of the signal from the one or more femtocells, wherein the strength of the signal from the one or more femtocells is compared to the local femtocell almanac to determine the position of the mobile station.

10. The method of claim 1, wherein the data code label comprises a Quick Response code.

11. The method of claim 1, wherein the data code label is encoded with a Uniform Resource Identifier (URI) and wherein obtaining positional information for the mobile station using the collected data comprises:
decoding the data code label to determine the URI; and
accessing and downloading the positional information for the mobile station using the URI.

12. A mobile station comprising:
a data code label reader being operable to read a data code label;
memory;
a display; and
a processing unit adapted to:
obtain positional information for the mobile station using data read from a data code label by the data code label reader;
provide the positional information for the mobile station;
update the positional information for the mobile station when the mobile station is moved; and
provide updated positional information for the mobile station.

13. The mobile station of claim 12, wherein the positional information comprises a digital map and a position for the mobile station; and wherein the updated positional information comprises a new position of the mobile station with respect to the digital map.

14. The mobile station of claim 12, wherein the positional information comprises directional information.

15. The mobile station of claim 12, wherein the positional information comprises non-navigational information.

16. The mobile station of claim 12, further comprising inertial sensors, wherein the inertial sensors provide inertial data; and wherein the processing unit is further adapted to use the inertial data to update the positional information for the mobile station when the mobile station is moved.

17. The mobile station of claim 12, further comprising:
a received signal strength indicator system for making received signal strength indicator measurements at the mobile station;
wherein the processing unit is further adapted to:
obtain a local wireless access point almanac on the mobile station; and
use the received signal strength indicator measurements and the local wireless access point almanac to update the position of the mobile station when the mobile station is moved.

18. The mobile station of claim 12, further comprising:
a received signal strength indicator system for making received signal strength indicator measurements at the mobile station;
wherein the processing unit is further adapted to:
obtain a local femtocell almanac on the mobile station; and
use the received signal strength indicator measurements and the local femtocell almanac to update the position of the mobile station when the mobile station is moved.

19. The mobile station of claim 12, wherein the data code label reader is configured to read a Quick Response code.

20. The mobile station of claim 12, wherein the processing unit is further adapted to download the positional information for the mobile station using a Uniform Resource Identifier (URI) that is encoded in the data code label.

21. A system for accessing and updating positional information for a mobile station comprising:
means for collecting data from a data code label;
means for obtaining positional information for the mobile station using the collected data;
means for providing the positional information for the mobile station; and
means for updating the positional information for the mobile station as the mobile station moves, wherein the means for providing provides the updated positional information for the mobile station.

22. The system of claim 21, wherein the positional information comprises a digital map and a position for the mobile station, and the means for updating the positional information comprises means for updating the position of the mobile station, and wherein the updated positional information comprises the updated position of the mobile station relative to the digital map.

23. The system of claim 21, wherein the positional information comprises directional information.

24. The system of claim 21, wherein the positional information comprises non-navigational information.

25. The system of claim 21, further comprising means for sensing movement of the mobile station, wherein the means for updating the positional information for the mobile station comprises means for using the sensed movement of the mobile station.

26. The system of claim 21, further comprising:
means for obtaining a local wireless access point almanac on the mobile station using the collected data; and
means for receiving a signal from one or more wireless access points that are in the local wireless access point almanac;
wherein the means for updating the positional information for the mobile station comprises means for using the local wireless access point almanac and the signal from the one or more wireless access points to update the position of the mobile station.

27. The system of claim 26, further comprising means for monitoring the strength of the signal received from the one or more wireless access points, wherein the strength of the signal from the one or more wireless access points is compared to the local wireless access point almanac to determine the positional of the mobile station.

28. The system of claim 21, further comprising:
means for obtaining a local femtocell almanac on the mobile station using the collected data; and
means for receiving a signal from one or more femtocells that are in the local femtocell almanac;
wherein the means for updating the positional information for the mobile station comprises means for using the local femtocell almanac and the signal from the one or more femtocells to update the position of the mobile station.

29. The system of claim 28, further comprising means for monitoring the strength of the signal received from the one or more femtocells, wherein the strength of the signal from the one or more femtocells is compared to the local femtocell almanac to determine the positional of the mobile station.

30. The system of claim 21, wherein the means for collecting data comprises a Quick Response code reader.

31. The system of claim 21, wherein the means for obtaining positional information for the mobile station comprises a web browser in the mobile station.

32. A computer-readable medium encoded with instructions which, when executed by a processing unit, perform operations, the instructions comprising:
code to decode a data code label;
code to obtain positional information using the decoded data code label;
code to provide positional information;
code to update the positional information when there is a change in position; and
code to provide the updated positional information.

33. The computer-readable medium of claim 32, the instructions further comprising code to update the positional information using inertial data provided by inertial sensors.

34. The computer-readable medium of claim 32, the instructions further comprising:
code to obtain a local wireless access point almanac using the decoded data code label;
code to measure the strength of a signal from one or more wireless access points that are in the local wireless access point almanac; and
code to update the positional information using the local wireless access point almanac and the measured strength of the signal.

35. The computer-readable medium of claim 32, the instructions further comprising:
code to obtain a local femtocell almanac using the decoded data code label;
code to measure the strength of a signal from one or more femtocells that are in the local femtocell almanac; and
code to update the positional information using the local femtocell almanac and the measured strength of the signal.
